(19) United States
(12) Patent Application Publication
(10) Pub. No.: US 2026/0077411 A1
(43) Pub. Date: Mar. 19, 2026

(54) ROTARY CUTTING TOOL WITH DIFFERENTIAL CORE PROFILE

(71) Applicant: Kennametal Inc., Latrobe, PA (US)

(72) Inventors: Leonid B. Sharivker, Nahariya (IL); Sergei Boulakhov, Naharyia (IL); Stephen M. George, Greensboro, NC (US); John Boyea, Greensboro, NC (US)

(73) Assignee: Kennametal Inc., Latrobe, PA (US)

(21) Appl. No.: 18/886,583

(22) Filed: Sep. 16, 2024

(51) Int. Cl. B23C 5/10

(52) U.S. Cl. CPC B23C 5/10

(57) ABSTRACT

A rotary cutting tool includes a shank portion and a cutting portion extending from the shank portion to a cutting end. The cutting portion has a plurality of blades separated by flutes about a cutter core with a differential core profile. The cutter core includes a first zone with an increasing or constant first diameter, D1, a second zone with a constant second diameter, D2, a third zone with a decreasing third diameter, D3, a fourth zone with an increasing fourth diameter, D4, and a fifth zone with an increasing fifth diameter, D5. A length, L1, from the cutting end to the third zone is approximately 0.20×D and 0.50×D, where D is a cutting diameter, D. The third zone has a length, L2, that is approximately 0.05×D and 0.20×D.

### FIELD OF THE DISCLOSURE

The invention pertains to a rotary cutting tool. More particularly, the invention relates to a milling cutter, such as a solid end mill, with a differential core to produce a cutting tool with improved stiffness and chip evacuation.

### BACKGROUND OF THE DISCLOSURE

At its most basic, milling is the meeting of a rotating tool with a clamped and stationary workpiece, as opposed to turning where the tool is stationary and the work material rotates. Actually, the workpiece has feed motion imparted from the machine tool. The meeting of the rotary motion of the cutter and the cutting edge of the tools produces fluctuating cutting forces: vibration, heat, and, if all goes well, chips.

Milling machines may have either vertical or horizontal spindle orientation, and typically, face milling cuts flat surfaces, but multi-axis computer numerical control (CNC) machines make it possible to include three-dimensional movements. That said, there are four basic categories of milling: face milling, periphery milling, slot milling, and specialty applications.

Face milling is used for creating a flat surface (face) on the workpiece. The cutting plane is usually perpendicular to the axis of rotation of the cutter. Surface finish requirements are an important input to determine the best tool type.

Periphery milling generates a primary surface parallel to the spindle rotation. A secondary surface is sometimes produced by the axial portion of the cutter while periphery milling. The cutting plane is usually parallel to the axis of rotation.

Slot milling is used for producing a slot or channel in the workpiece. There are two primary types of slot milling cutters: disk mills and end mills. Disk mills can be high-speed steel, brazed carbide, and indexable-insert-based. They are typically used in operations perpendicular to the spindle rotation.

End mills used for slot-milling operations are similar to the tools used in periphery milling. The slot being generated is parallel to the spindle rotation.

End mills are frequently used because they can execute a wide variety of milling operations, and the initial cost of the cutter is moderate. Shapes other than cylindrical are also in common use. The shank can be parallel or tapered and need not necessarily be equal to the cutter teeth diameter.

The current trend in end milling applications is to increase the material removal rate (MRR), chip loads, ramping angles and in general heavier cuts. This drives development toward needing to increase room for chips in the flutes, which leads to smaller core profiles. This in turn leads to generally smaller core cross sections in the flutes which reduces the strength of the tool, especially in bending.

### SUMMARY OF THE DISCLOSURE

The problem of increasing the room for chips in the flutes, while maintaining or increasing the strength of the cutting tool is solved by creating a differential core profile that always starts with a larger diameter at the front section and follows with proportionally smaller diameter at the mid-section and then increasing toward the back section of a flute. Alternatively, we can create a wave pattern of decreasing the core and increasing along the length of cut.

In one aspect, a rotary cutting tool comprises a shank portion and a cutting portion extending from the shank portion to a cutting end. The cutting portion has a plurality of blades separated by flutes about a cutter core having a differential core profile. The cutter core has a first zone extending entirely along a central, longitudinal axis, A, from the cutting end with a first diameter, D1 to a second zone with a second diameter. The second zone extends entirely along the central, longitudinal axis, A, to a third zone with a third diameter, D3. The third zone extends entirely along the central, longitudinal axis, A, to a fourth zone with a fourth diameter, D4. The fourth zone extends entirely along the central, longitudinal axis, A, to a fifth zone with a fifth diameter, D5. The first diameter, D1, increases from the cutting end to the second zone. The second diameter, D2, is constant. The third diameter, D3, decreases from the second zone to the fourth zone. The fourth diameter, D4, increases from the third zone to the fifth zone. The fifth diameter, D5, increases from the fourth zone to the shank portion.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is a side view of a rotary cutting tool with a cutter core (shown in phantom) with differential core profile in accordance with an embodiment of the disclosure;

FIG. 2 is a partial enlarged view of the rotary cutting tool of FIG. 1 showing the differential core profile of the cutter core according to one aspect of the disclosure;

FIG. 3 is a partial greatly enlarged view of the rotary cutting tool of FIG. 1 showing the differential core profile of the first, second and third zones of the cutter core;

FIG. 4 is a side view of a rotary cutting tool with a cutter core (shown in phantom) with differential core profile with a wave core profile in accordance with another embodiment of the disclosure;

FIG. 5 is a partial enlarged view of the rotary cutting tool of FIG. 4 showing the differential core profile of the cutter core with the wave core profile according to one aspect of the disclosure;

FIG. 6 is a partial greatly enlarged view of the rotary cutting tool of FIG. 4 showing the differential core profile of the first, second and third zones of the cutter core;

FIG. 7 is a partial enlarged view of a rotary cutting tool showing the differential core profile of the cutter core having a first zone with a substantially constant diameter according to another aspect of the disclosure; and

FIG. 8 is a partial greatly enlarged view of the rotary cutting tool of FIG. 7 showing the differential core profile of the first, second and third zones of the cutter core.

### DETAILED DESCRIPTION OF THE DISCLOSURE

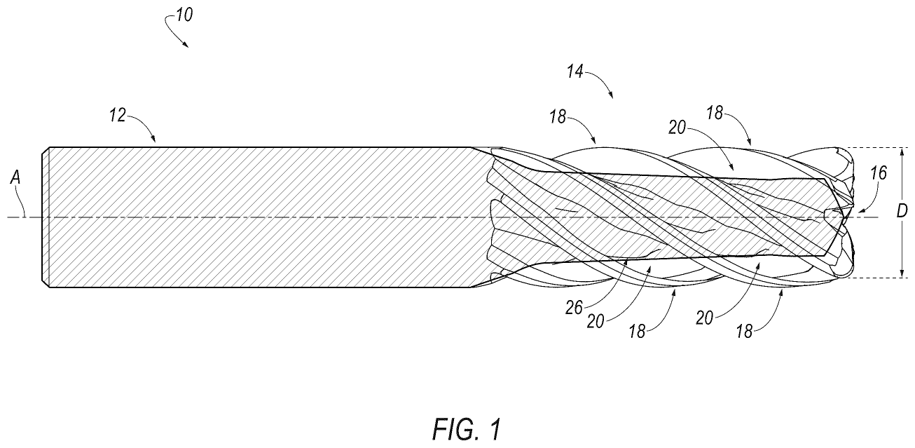

Referring now to FIGS. 1-3, a rotary cutting tool 10 is provided that includes a shank portion 12, a cutting portion 14 having a cutting end 16, and a central, longitudinal axis, A. In the illustrated embodiment, the rotary cutting tool 10 comprises a solid end mill having a cutting diameter, D. The overall shape of the cutting portion 14 may be, but is not limited to, a cylindrical shape or a frustoconical shape. The cutting portion 14 has a plurality of blades 18 separated by flutes 20. The plurality of blades 18 and flutes 20 extend the length of the cutting portion 14. Each of the blades 18 has a relief surface, shown generally at 22, and a radial (i.e., side) cutting edge 24 formed at the intersection between the flute 20 and the relief surface 22. The flutes 20 extend the length of the cutting portion 14 about a cutter core 26.

In the illustrated embodiment, the end mill 10 has a total of five blades 18 and flutes 20. However, it will be appreciated that the disclosure is not limited by the number of blades and flutes, and that the disclosure can be practiced with a fewer or a greater number of blades and flutes. For example, the disclosure can be practiced with two blades and flutes, three blades and flutes, four blades and flutes, six blades and flutes, seven blades and flutes, eight blades and flutes, and the like.

The blades 18 and flutes 20 of the cutting portion 14 extend helically within the cutting portion 14 at a helix angle, HA, of between about twenty-five and about fifty degrees with respect to the central, longitudinal axis, A. In another embodiment, the blades 18 and flutes 20 are “straight flutes” that extend parallel to the longitudinal axis, A. In the illustrated embodiment, the blades 18 and flutes 20 of the cutting portion 14 extend helically within the cutting portion 14 at a helix angle, HA, of about 35 degrees. It will be appreciated that the disclosure is not limited by the magnitude of the helix angle, HA, and that the disclosure can be practiced with any desirable helix angle, HA.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Throughout the text and the claims, use of the word “about” in relation to a range of values (e.g., “about 22 to 35 wt. %”) is intended to modify both the high and low values recited, and reflects the penumbra of variation associated with measurement, significant figures, and interchangeability, all as understood by a person having ordinary skill in the art to which this invention pertains.

For purposes of this specification (other than in the operating examples), unless otherwise indicated, all numbers expressing quantities and ranges of ingredients, process conditions, etc. are to be understood as modified in all instances by the term “about”. Accordingly, unless indicated to the contrary, the numerical parameters set forth in this specification and attached claims are approximations that can vary depending upon the desired results sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Further, as used in this specification and the appended claims, the singular forms “a”, “an” and “the” are intended to include plural referents, unless expressly and unequivocally limited to one referent.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements including that found in the measuring instrument. Also, it should be understood that any numerical range recited herein is intended to include all sub-ranges subsumed therein. For example, a range of “1 to 10” is intended to include all sub-ranges between and including the recited minimum value of 1 and the recited maximum value of 10, i.e., a range having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

As used herein, “differential” is defined as differing or varying in an axial direction of the milling cutter.

As used herein, “core diameter” is the solid center of the milling cutter defining the roots of the flutes.

As used herein, “parabolic” is having a form of a parabola defined as a plane curve that is mirror-symmetrical and is approximately U-shaped.

As used herein, “hyperbolic” is having a form of a hyperbola defined as an open curve with two branches, the intersection of a plane with both halves of a double cone. The plane does not have to be parallel to the axis of the cone, but the hyperbola will be symmetrical in any case.

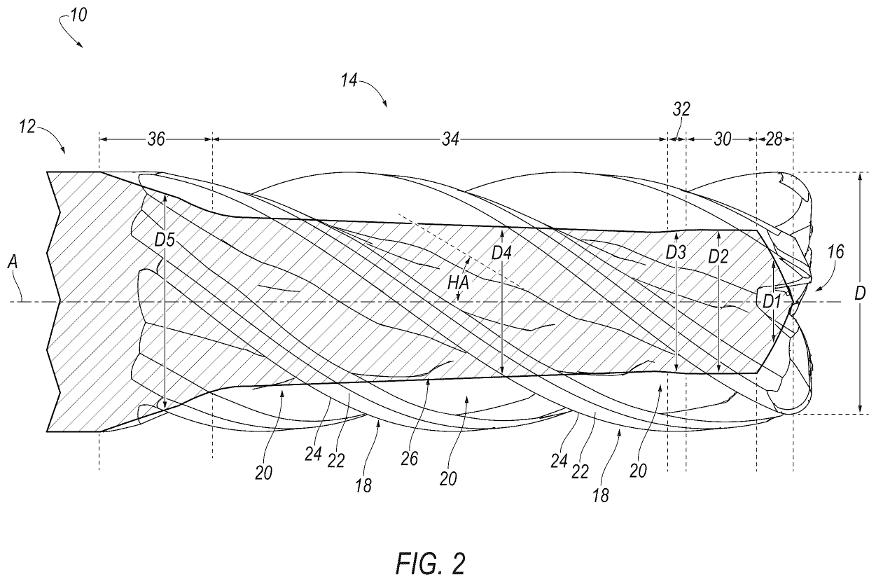

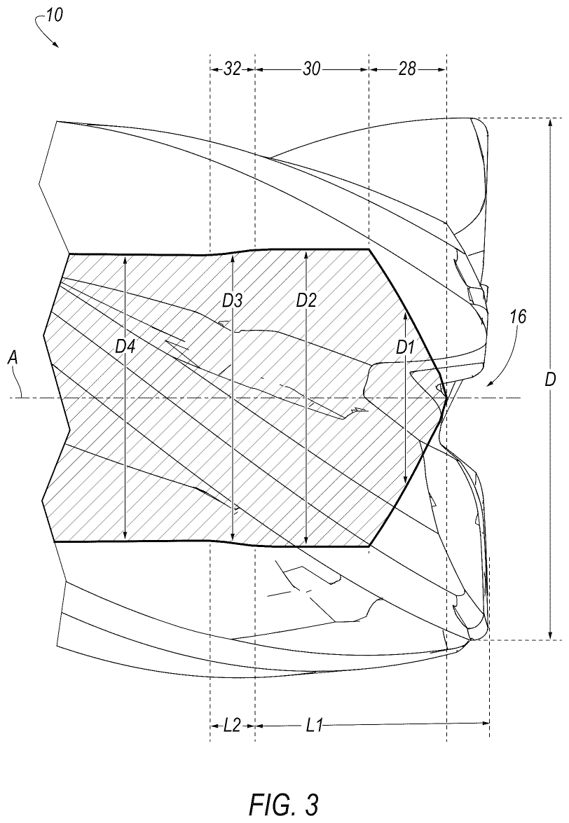

Referring now to FIGS. 1-3, the rotary cutting tool 10 has a core 26 with a differential core profile (shown in phantom) according to an aspect of the disclosure. As shown in FIGS. 2 and 3, the cutter core 26 of the disclosure has a first zone 28, a second zone 30, a third zone 32, a fourth zone 34 and a fifth zone 36. Each of the zones 28, 30, 32, 34, 36 have a different core profile.

The first zone 28 extends entirely between the cutting end 16 and the second zone 30. The first zone 28 has a diameter, D1, that is essentially zero at the central, longitudinal axis, A, and sharply increases to the second zone 30. In the illustrated embodiment, the diameter, D1, of the first zone 28 sharply increases with a substantially linear core profile. However, it will be appreciated that the diameter, D1, of the first zone 28 may sharply increase in a concave parabolic core profile, a convex parabolic core profile, a hyperbolic core profile, and the like.

The second zone 30 extends entirely between the first zone 28 and the third zone 32 and has a diameter, D2, that is substantially constant. In other words, the second zone 30 has a substantially constant diameter core profile. The diameter, D2, of the second zone 30 is sufficiently large in magnitude to strengthen the end of the cutting tool 10 by creating a large enough core 26 at the cutting end 16 of the cutting tool 10 having flutes 20 where the gash (not shown) is located. The larger diameter, D2, also provides greater cross-sectional area for the gashing to create blades 18 with relatively larger width at the cutting end 16.

In one aspect, the length, L1, along the central, longitudinal axis, A, from the cutting tip 16 to the third zone 32, i.e., including the first zone 28 and the second zone 30, is between approximately one-fifth and approximately one-half of the cutting diameter, D, as shown in FIG. 3. In other words, the length, L1, is between approximately 0.20×D and approximately 0.50×D. For example, the length, L1, may be approximately 0.33×D, where D is the cutting diameter, D.

The third zone 32 extends entirely between the second zone 30 and the fourth zone 34 and has a diameter, D3, that continuously decreases from the second zone 30 to the fourth zone 34. The third zone 32 has a length, L2, that is significantly less than the length, L2, of the second zone 30. For example, the length, L2, of the third zone 32 can be between approximately 0.05×D and approximately 0.20×D, where D is the cutting diameter. In the illustrated embodiment, the length, L2, is approximately 0.10×D, where D is the cutting diameter. Thus, the third zone 32 can be considered a transition zone in which the diameter, D2, of the second zone 30 rapidly decreases between the second zone 30 and the fourth zone 34. The decrease in diameter, D3, of the core profile at third zone 32 along the central, longitudinal axis, A, provides sufficient space for chip formation where space is most desirable. In the illustrated embodiment, the diameter, D3, of the third zone 32 decreases with a substantially linear core profile. However, it will be appreciated that the diameter, D3, of the third zone 32 may decrease with a concave parabolic core profile, a convex parabolic core profile, a hyperbolic core profile, and the like.

The fourth zone 34 extends entirely between the third zone 32 to the fifth zone 36 and has a diameter, D4, that gradually increases from the third zone 32 to the fifth zone 36. This increase in the diameter, D4, provides sufficient overall structural strength for cutting operations, such as ramping, slotting, heavy side milling, and the like. In the illustrated embodiment, the diameter, D4, of the fourth zone 34 gradually increases with a continuous linear core profile. However, it will be appreciated that the diameter, D4, of the fourth zone 34 may increase with a concave parabolic core profile, a convex parabolic core profile, a hyperbolic core profile, and the like.

The fifth zone 36 extends entirely between the fourth zone 34 and the shank portion 12 and has a diameter, D5, that increases from the fourth zone 34 to the shank portion. In the illustrated embodiment, the diameter, D5, of the fifth zone 36 increase with a convex parabolic core profile. However, it will be appreciated that the diameter, D5, of the fifth zone 36 may increase with a concave parabolic core profile, a convex parabolic core profile, a hyperbolic core profile, and the like.

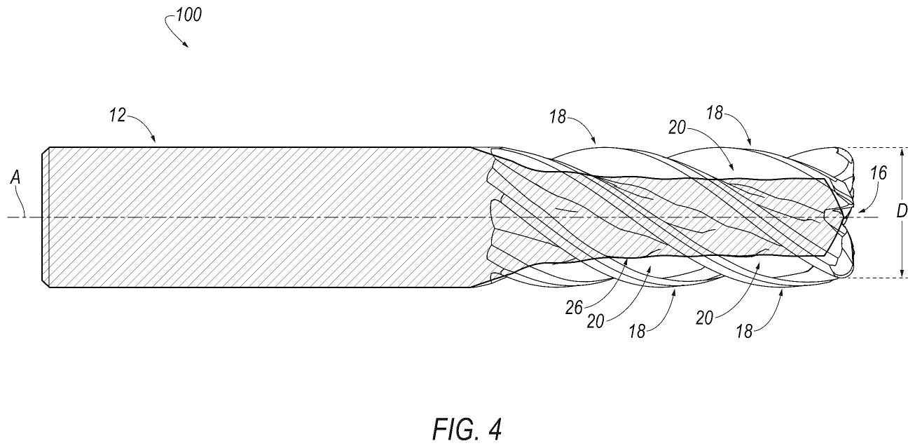

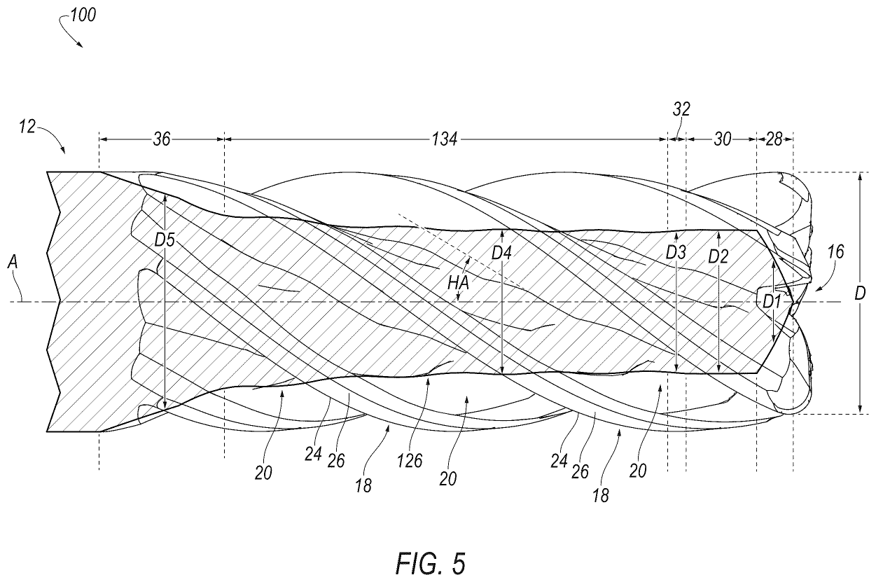

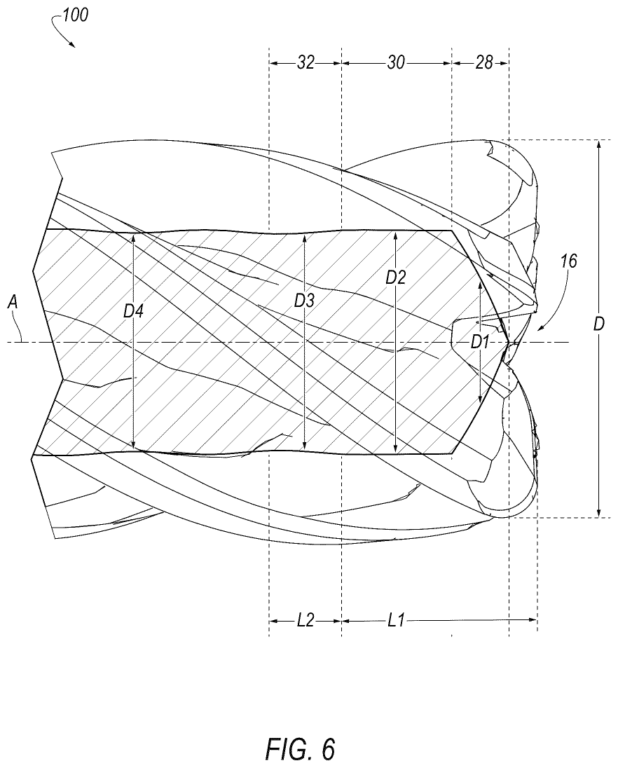

Referring now to FIGS. 4-6, a rotary cutting tool 100 is shown according to another aspect of the disclosure. In this aspect, the rotary cutting tool 100 is substantially identical to the rotary cutting tool 10, except the fourth zone 134 of the cutter core 126 has a wave core profile. In other words the fourth zone 134 comprises a series of peaks and valleys having a predetermined amplitude.

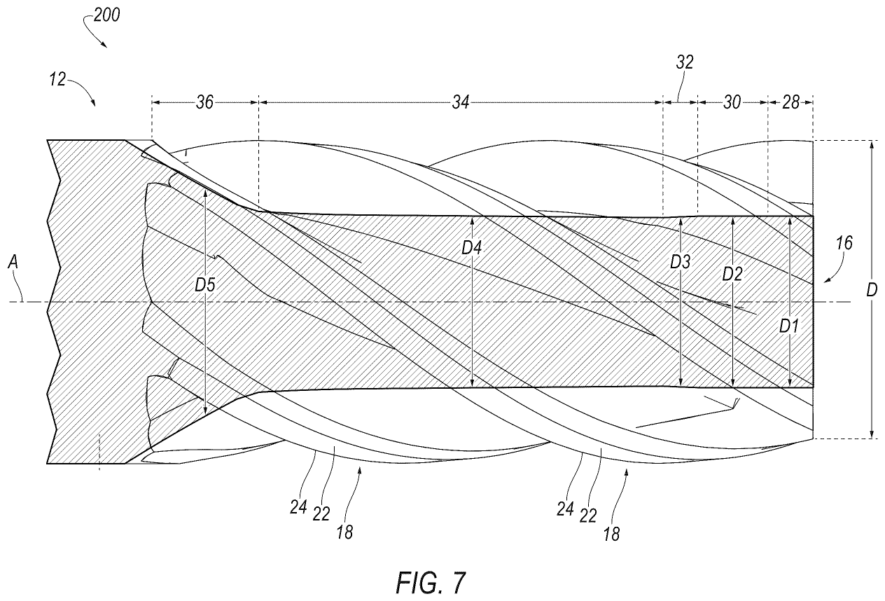

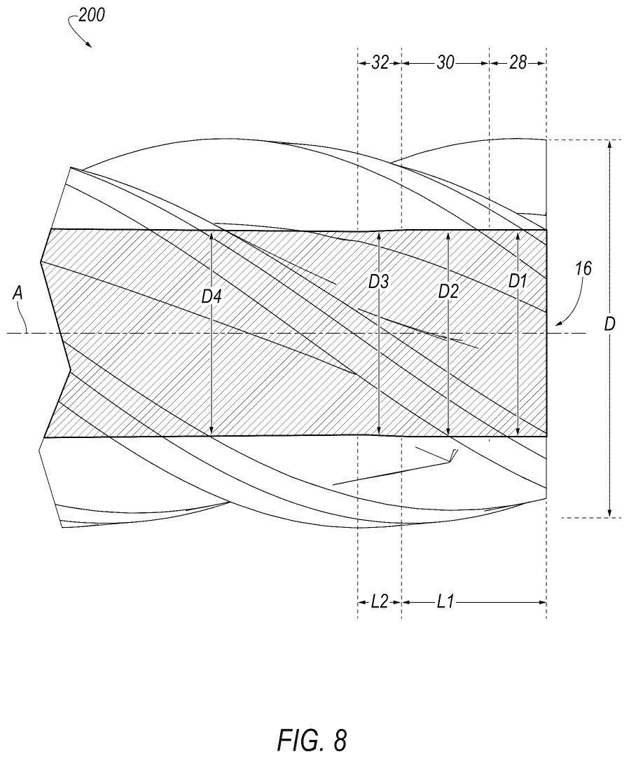

In the earlier embodiments, the rotary cutting tool 10, 100 includes one or more gashes (not shown) formed in the cutting end 16. However, the principles of the disclosure can be applied to a rotary cutting tool 200 that does not include gashes formed in the cutting end 16, as shown in FIGS. 7 and 8. This embodiment of the rotary cutting tool 200 is substantially identical to the earlier embodiment of the rotary cutting tool 10, 100 with gashes, except the first zone 28 has a substantially constant diameter, D1. In the illustrated embodiment, the diameter, D1, is approximately equal to the diameter, D2, of the second zone 30. However, it will be appreciated that the diameter, D1, can be different than the second diameter, D2.

As described above, the differential core profile of the disclosure provides technical advantages over conventional milling cutters as follows:
1. Greater flexibility in differentiating volume of the flute 20 along the cutting edge 24;
2. Greater flexibility in fine tuning of the balance between the strength of the flute 20 and the volume of the flute 20 to create and evacuate chips; and
3. Greater flexibility to create sort of “rugged” surface of the flute 20 for improved retaining of coolant and chip flow.

The patents and publications referred to herein are hereby incorporated by reference.

Having described presently preferred embodiments the invention may be otherwise embodied within the scope of the appended claims.

What is claimed is:

1. A rotary cutting tool, comprising:
a shank portion; and
a cutting portion extending from the shank portion to a cutting end, the cutting portion having a plurality of blades separated by flutes about a cutter core having a differential core profile,
wherein the cutter core has a first zone extends entirely along a central, longitudinal axis, A, from the cutting end with a first diameter, D1 to a second zone with a second diameter, D2,
wherein the second zone extends entirely along the central, longitudinal axis, A, to a third zone with a third diameter, D3,
wherein the third zone extends entirely along the central, longitudinal axis, A, to a fourth zone with a fourth diameter, D4,
wherein the fourth zone extends entirely along the central, longitudinal axis, A, to a fifth zone with a fifth diameter, D5,
wherein the second diameter, D2, is substantially constant,
wherein the third diameter, D3, decreases from the second zone to the fourth zone,
wherein the fourth diameter, D4, increases from the third zone to the fifth zone, and
wherein the fifth diameter, D5, increases from the fourth zone to the shank portion.

2. The rotary cutting tool of claim 1, wherein the first diameter, D1, increases from the cutting end to the second zone.

3. The rotary cutting tool of claim 1, wherein the first diameter, D1, is substantially constant.

4. The rotary cutting tool, wherein at least one of the third zone, the fourth zone and the fifth zone has one of a concave parabolic core profile, a convex parabolic core profile and a hyperbolic core profile.

5. The rotary cutting tool of claim 1, wherein a length, L1, along the central, longitudinal axis, A, from the cutting tip to the third zone is between approximately 0.20×D and approximately 0.50×D, where D is a cutting diameter of the rotary cutting tool.

6. The rotary cutting tool of claim 1, wherein the third zone has a length, L2, that is between 0.05×D and approximately 0.20×D, where D is a cutting diameter of the rotary cutting tool.

7. The rotary cutting tool of claim 1, wherein each of the blades includes a relief surface and a radial cutting edge formed at an intersection between a respective flute and the relief surface.

8. The rotary cutting tool according to claim 1, wherein each blade forms a helix angle, HA, between approximately twenty-five degrees and approximately fifty degrees with respect to a central, longitudinal axis, A, of the rotary cutting tool.

9. The rotary cutting tool according to claim 1, wherein the rotary cutting tool comprises a solid end mill.

10. The rotary cutting tool of claim 1, wherein the fourth zone of the cutter core has a wave core profile.
